(19) United States
(12) Patent Application Publication
(10) Pub. No.: US 2026/0359609 A1
(43) Pub. Date: Nov. 12, 2026

(54) Al System for Real-Time Decision Optimization in Dynamic Data Environments

(71) Applicants: Anand Chauhan, Newark, NJ (US); Lakshya Sahai, Newark, NJ (US); Shreya Gurunath Tendulkar, Syracus, NJ (US)

(72) Inventors: Anand Chauhan, Newark, NJ (US); Lakshya Sahai, Newark, NJ (US); Shreya Gurunath Tendulkar, Syracus, NJ (US)

(21) Appl. No.: 19/714,681

(22) Filed: Jun. 22, 2026

(51) Int. Cl. G06N 3/0455; G06F 9/52; G06N 3/0475

(52) U.S. Cl. CPC G06N 3/0455; G06F 9/52; G06N 3/0475

(57) ABSTRACT

An artificial intelligence (AI) system (10) executes real-time decision optimization within high-velocity, non-stationary dynamic data environments. The architecture includes a streaming input pipeline (16) that ingests heterogeneous multi-variant data streams from distributed endpoints (12), transforming payloads into high-dimensional tensors verified by an anomaly autoencoder (20). A context-aware adaptive neural router (24) extracts context signatures via a gating network (26) to dynamically activate a specialized neural sub-network expert (28), reducing computational overhead by bypassing dormant network clusters. An evolving multi-tier memory allocation mesh (40) separates transient learning adjustments in a short-term buffer (42) from a consolidated baseline core network (46) to eliminate concept drift and catastrophic forgetting. An inline actor-critic reinforcement learning engine (52) drives policy generation using parallelized, lock-free gradient descent to maintain sub-10-millisecond execution latencies. An automated resource-hardware adaptation matrix (70) applies structural pruning and dynamic weight quantization based on real-time host metrics (74) under a deterministic safety guardrail controller (62).

### FIELD OF INVENTION

The present invention relates generally to artificial intelligence systems and machine learning architectures, and more particularly to a computer-implemented artificial intelligence (AI) framework configured for high-throughput, low-latency contextual processing and real-time decision optimization within multi-variant, non-stationary dynamic data streaming environments.

### BACKGROUND

Enterprise data environments have transitioned from static, batch-processed storage repositories to highly fluid, asynchronous, distributed data streams. Modern infrastructure networks—such as Internet-of-Things (IoT) sensor meshes, financial transaction ledgers, autonomous vehicle arrays, and telecommunication switches—generate heterogeneous data packets at unprecedented volumes and velocities. These environments are characterized by “non-stationary” behaviors, meaning the underlying statistical properties, data distributions, and operational variables change continuously and unpredictably over time.

Traditional rule-based engines and deterministic decision-support systems are fundamentally incapable of operating effectively within such dynamic data environments. These legacy configurations rely on rigid, pre-programmed decision trees that require static input boundaries. When exposed to real-time structural shifts or anomalous data anomalies, static engines fail to adapt, leading to cascading analytical computational errors, suboptimal decisions, or absolute system latency bottlenecks.

Standard machine learning models, such as basic deep neural networks (DNNs) or recurrent neural networks (RNNs), also suffer from critical systemic vulnerabilities when deployed in highly volatile settings. Chief among these is the problem of “concept drift,” where a model trained on historical offline training data loses predictive accuracy as the real-time operational data distribution shifts. To correct for concept drift, conventional systems must take the model offline to perform computationally expensive retraining cycles, sacrificing real-time decision continuity.

Furthermore, traditional AI frameworks exhibit a phenomenon known as “catastrophic forgetting.” When a model is updated or fine-tuned with new streaming data to adapt to a changing environment, it often overwrites or completely erases its previously learned core operational weights and logical competencies. Consequently, the system lacks the structural plasticity required to balance the retention of historical baseline intelligence with the assimilation of newly emerging real-time data trends.

Computational latency presents another acute barrier to real-time execution in dynamic environments. Processing high-frequency data streams requires significant hardware infrastructure, often involving multiple nodes across a cloud architecture. The sequential extraction, transformation, loading (ETL), and inference execution tasks introduce substantial networking propagation delays, making it impossible to meet sub-millisecond real-time critical decision-making window thresholds.

Edge computing variants attempt to resolve latency by moving inference models closer to the data source, but they introduce severe hardware resource constraints. Mobile nodes, edge gateways, and local sensors possess highly restricted central processing unit (CPU) cycles, limited random-access memory (RAM), and constrained thermal parameters. Standard high-parameter AI architectures cannot be directly compiled or executed on such hardware without causing computational overruns, memory faults, or total power starvation.

Existing multi-agent or ensemble machine learning techniques attempt to distribute the computational load by running multiple models concurrently and averaging their outputs. However, these systems lack an intelligent, context-aware routing layer. As a result, they suffer from significant resource overhead, processing every stream through every model sub-component simultaneously, which redundantizes network bandwidth and increases system power consumption metrics exponentially.

Furthermore, data streams in high-throughput environments are frequently compromised by missing parameters, unstructured noise, or asynchronous timing offsets. Conventional statistical data imputation models introduce artificial biases or require multi-pass algorithmic scans over the data stream, which adds significant processing overhead and invalidates the “real-time” performance constraint required for critical operational execution.

From an architectural perspective, current feedback-loop mechanics within decision optimization systems operate on delayed evaluation schedules. Reward functions or loss gradients are typically computed post-facto in batched intervals. This lack of immediate, closed-loop telemetry updates prevents the system from self-correcting its optimization parameters in lockstep with fast-fading environmental anomalies.

Consequently, there exists a critical, unfulfilled technological need for an advanced AI system architecture capable of executing continuous, real-time decision optimization within dynamic data environments. Such a system must feature inline adaptation to concept drift without offline retraining dependencies, mitigate catastrophic forgetting through structured parameter isolation, optimize computational resource allocation via dynamic context-routing, and guarantee deterministic, ultra-low latency execution across heterogeneous distributed computing networks.

### SUMMARY OF THE INVENTION

To achieve the aforementioned objectives, the present invention discloses a system, method, and non-transitory computer-readable medium encoding an AI framework for real-time decision optimization in dynamic data environments. The architecture comprises an integrated streaming input pipeline, a context-aware adaptive neural router, an evolving multi-tier memory allocation mesh, a continuous inline optimization engine, and an automated resource-hardware adaptation matrix.

The streaming input pipeline is configured to ingest high-frequency, heterogeneous multi-variant data streams directly from distributed endpoints. The pipeline incorporates an inline vectorization engine that transforms raw unstructured data packets into structured high-dimensional tensor representations. Concurrently, an anomaly-aware autoencoder layer scans the incoming tensors to detect and isolate noise variations and fill missing data packets via predictive generation.

Crucial to the architecture is the context-aware adaptive neural router, which intercepts the generated high-dimensional tensors. Rather than passing the data through a static deep network, the neural router extracts an embedded context signature from the tensor stream. This signature is evaluated against an array of specialized, modular neural sub-networks, allowing the router to dynamically activate only the specific computational pathway optimized for the current data context.

Continuous learning without performance degradation is achieved via the evolving multi-tier memory allocation mesh. This system separates new information updates from core historical models. The mesh includes a transient short-term buffer for real-time adjustments, an episodic cache for intermediate pattern tracking, and a consolidated baseline core network that undergoes secure asynchronous update cycles during periods of low system utilization.

The decision optimization layer is driven by an inline deep reinforcement learning engine utilizing an actor-critic paradigm. The actor network generates optimized operational actions or policies based on the context-routed tensors, while the critic network continually monitors real-time system performance rewards. Gradients are optimized using a parallelized, asynchronous gradient tracking layout, ensuring ultra-low latency response times below 10 milliseconds.

To accommodate deployment across heterogeneous processing platforms, the system incorporates an automated resource-hardware adaptation matrix. This module continuously tracks local hardware metrics such as CPU usage, available RAM, and power consumption. Based on these parameters, the matrix applies structural pruning, weight clustering, or dynamic bit-width quantization to the active neural pathways, downscaling the compute requirements on the fly.

In another aspect of the invention, the system includes a multi-scale drift detection engine that computes a running statistical variance score of the input tensor distributions. When the variance score exceeds a predefined mathematical threshold, indicating structural drift, the drift engine triggers an automated generation of a new specialized neural sub-network module within the adaptive router's array.

In another aspect of the invention, the distributed processing nodes communicate optimization gradients utilizing a specialized sparse synchronization technique. This layer ensures that only non-zero, high-impact weight updates are transmitted across the networking fabric, thereby conserving immense amounts of network bandwidth and preventing packet collision bottlenecks.

In another aspect of the invention, the decision outputs of the optimization engine are governed by a deterministic safety guardrail controller. This layer intercepts all generated AI actions and applies hard-coded baseline operational limits, ensuring that the system never issues an optimized action vector that breaches safe structural or regulatory compliance parameters.

Ultimately, the collective integration of these modular layers yields an autonomous AI engine that scales dynamically to process millions of complex multi-variant data points per second, executing optimal operational policies with absolute resilience to concept drift, hardware variances, and data corruption issues.

### BRIEF DESCRIPTION OF THE DRAWINGS

FIG. 1 illustrates a generalized architectural block diagram of the AI System for Real-Time Decision Optimization in Dynamic Data Environments, highlighting the primary functional layers and the directional data flow between them according to an exemplary embodiment of the present invention.

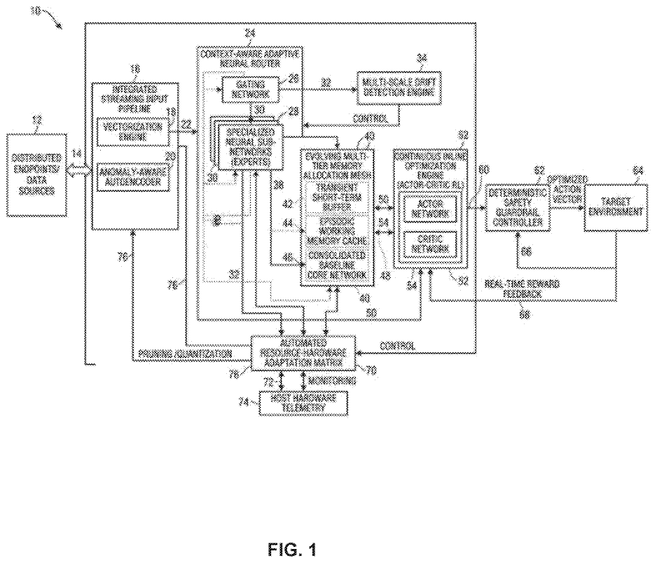

FIG. 2 illustrates a highly detailed technical flowchart delineating the sequence of data processing operations, context routing steps, continuous gradient calculation updates, and adaptive edge hardware scaling mechanisms executed by the system according to an exemplary embodiment of the present invention.

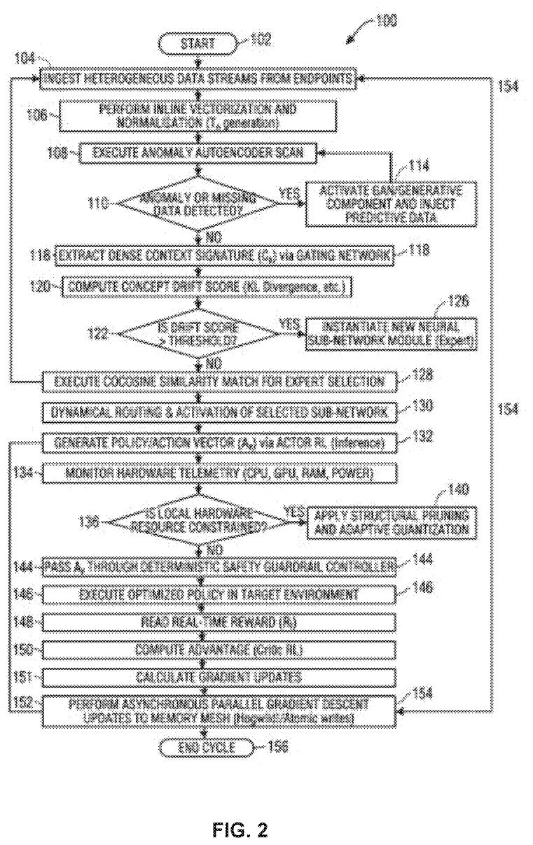

### DETAILED DESCRIPTION

The present disclosure details a highly advanced computer system architecture, computational methods, and functional algorithmic modules comprising an Artificial Intelligence (AI) System 10 for Real-Time Decision Optimization in Dynamic Data Environments. The structural components of this invention are designed to work together smoothly to ingest raw data feeds, optimize computational tasks, and issue high-performance, real-time control actions within complex distributed network topologies.

At the core of the system 10 is a highly optimized Streaming Input Pipeline (represented within the Integrated Streaming Input Pipeline 16). This pipeline features specialized network interface wrappers designed to establish low-overhead socket connections 14 with thousands of distributed endpoints/data sources 12. The incoming streams consist of heterogeneous structural types, which may include structured time-series metrics, semi-structured JSON payloads, or unstructured raw binary blobs.

To parse this data without incurring processing latency, the pipeline deploys a parallelized Ingestion Framework (configured to ingest heterogeneous data streams 104) that maps incoming data chunks into unified, high-dimensional memory arrays. The data are processed in-memory using lock-free ring buffers that prevent typical thread contention and race conditions. This ensures that the system maintains a continuous data ingestion capability exceeding hundreds of megabytes per second.

Concurrently, an inline Vectorization Engine 18 processes the ingested data blocks into standardized tensor data structures, denoted as Tx (as shown in block 106). This vectorization involves performing mapping, normalizing numerical values within a zero-to-one range, and encoding categorical string variables into uniform mathematical embeddings. This transforms diverse real-world parameters into clean vectors optimized for deep learning execution.

To handle real-world data corruption, the pipeline integrates an Anomaly-Aware Autoencoder 20. This autoencoder 20 is a deep neural network variant trained to compress incoming tensors 22 into low-dimensional representations and then reconstruct them (as executed in step 108). By evaluating the structural mathematical difference between the input tensor and the output reconstruction tensor—known as the reconstruction error—the autoencoder 20 flags corrupted or malicious data packets (as checked at decision block 110).

If the reconstruction error for a specific tensor packet exceeds a mathematically defined standard deviation threshold, the autoencoder 20 isolates that packet from the primary learning stream. It then activates a GAN/generative component 114 that uses surrounding contextual vectors to synthesize replacement data parameters and inject predictive data, filling any data gaps without halting the overall execution flow.

The clean tensor vectors then pass immediately via data path 22 to the Context-Aware Adaptive Neural Router 24. Unlike standard static deep neural networks that feed every data input through an extensive, monolithic structure of millions of parameters, the neural router 24 of the present invention acts as an intelligent, dynamic gating mechanism to ensure extreme computational efficiency.

The neural router 24 includes a low-overhead, high-speed gating network 26 that extracts a dense context signature vector, $C_s$, from each incoming tensor (as executed in step 118). This context signature acts as a concise mathematical summary of the current operational state of the dynamic environment. The router 24 maps this context signature against an active directory of specialized neural sub-networks (experts) 28 via control paths 30.

Each specialized neural sub-network 28 within the system is trained and fine-tuned to excel at a specific operational subset of the environment. For example, within a telecommunications context, one expert network is tuned for peak daytime traffic congestion profiles, while another is configured for late-night maintenance arrays. The router 24 matches the context signature to the most relevant expert using a cocosine similarity match execution 128.

Once the target sub-network is selected, the router 24 dynamically shifts the computational data path through dynamical routing and activation 130 to direct the tensor stream exclusively to that specialized neural sub-network 28. The weights and parameters of all other inactive sub-network modules are kept in a dormant state or paged out of primary GPU/VRAM memory caches, minimizing system power consumption and saving massive amounts of compute overhead.

To continuously monitor for structural shifts in the environment over time, the router 24 works in tandem via path 32 with a Multi-Scale Drift Detection Engine 34. This engine 34 tracks the statistical distributions of the incoming context signatures and computes a concept drift score 120 using a rolling window variance analysis (such as KL Divergence). If the statistical properties of the environment drift significantly from historical baselines, a concept drift flag is raised.

When a drift flag is raised (as determined when the drift score exceeds a threshold 122), it indicates that the existing array of specialized sub-networks 28 no longer accurately represents the new environmental realities. In response, the system automatically instantiates a new neural sub-network module (expert) 126 within the router's directory, seeding its initial weights from the closest matching historical expert to begin learning the new data characteristics.

Continuous stream learning without performance degradation is governed by an Evolving Multi-Tier Memory Allocation Mesh 40. This mesh 40 solves the problem of catastrophic forgetting by splitting memory into distinct functional layers: a Transient Short-Term Buffer 42, an Episodic Working Memory Cache 44, and a Consolidated Baseline Core Network 46.

The Transient Short-Term Buffer 42 captures the real-time weight adjustments calculated during ongoing inference and optimization tasks. These modifications are temporary and isolated to prevent unverified data from immediately altering the core models. The buffer 42 allows the system to remain highly responsive to temporary localized variations without corrupting its long-term baseline knowledge.

As patterns in the transient buffer 42 prove stable over a specific time horizon, they are moved via interface 38 to the Episodic Working Memory Cache 44. This cache 44 tracks medium-term trend variances. To integrate this knowledge into the primary model without causing disruption, an asynchronous consolidation controller runs in the background via interface 48 to slowly blend the episodic weights into the Consolidated Baseline Core Network 46.

This consolidation process uses an elastic weight consolidation technique. It calculates a Fisher information matrix to identify which historical parameters and connections are most critical to the system's core capabilities. During optimization updates, a mathematical penalty is applied to protect those vital nodes, allowing new operational strategies to be learned on less critical pathways.

The primary optimization tasks are driven by a Continuous Inline Optimization Engine (Actor-Critic RL) 52 configured in an Actor-Critic architecture. The Actor network reads the context-routed tensor state via path 50 and generates a policy/action vector, $A_v$, via inference 132. This vector represents the optimal decision—such as routing a network packet, adjusting a financial position, or tuning an industrial actuator.

Simultaneously, the Critic network evaluates the action vector against a real-time reward feedback function 68 provided by telemetry links from the target environment 64. The Critic computes an advantage value 150 that measures how much better the chosen action performed compared to the baseline expectation. This advantage value is used to calculate gradient updates 151 to modify the underlying parameters of both networks.

To achieve ultra-low execution latency, the reinforcement learning engine 52 implements an Asynchronous Parallel Gradient Descent Layer (as shown in block 154). This framework breaks down gradient descent operations into independent, concurrent tasks that execute across multiple parallel GPU threads. The threads update shared weight matrices within the memory mesh 40 via path 54 using lock-free atomic write instructions (such as Hogwild!/Atomic writes), ensuring continuous optimization loops before ending the cycle 156.

To guarantee safe and compliant execution in critical settings, the generated action vectors 60 are passed through a Deterministic Safety Guardrail Controller 62 before final output. This controller 62 maintains a strict, hard-coded lookup matrix of absolute operational boundaries. If the AI engine outputs an action vector that exceeds these safe operational boundaries, the guardrail controller 62 intercepts via path 66, modifies it, and outputs an optimized action vector 62 to the target environment 64.

To support deployments across varying infrastructure classes, the system incorporates an Automated Resource-Hardware Adaptation Matrix 70. This module 70 acts as a continuous optimization loop focused on the host system's hardware performance. It interfaces via path 72 to monitor host hardware telemetry 74 (such as CPU, GPU, RAM, and power 134) to check if local hardware resources are constrained 136.

If the adaptation matrix 70 notes that the host system is experiencing severe resource constraints—such as an edge gateway node with low battery power and high memory usage—it automatically triggers an inline model compression sequence via feedback paths 76. This sequence applies structural parameter pruning 140 to the active sub-network pathways, removing less important neural connections.

Additionally, the matrix 70 dynamically applies adaptive quantization 140 to adjust the numeric bit-width representation of the neural weights, scaling down from standard 32-bit floating-point accuracy to efficient 8-bit or 4-bit integer values. This dynamic quantization reduces the memory footprint and accelerates processing speeds on edge hardware, while automatically reversing back to higher precision once resource levels recover, before passing the action vector Av through the deterministic safety guardrail controller 144 to execute the optimized policy in the target environment 146.

Communication across distributed instances of this AI framework is optimized by a Sparse Gradient Synchronization Layer (integrated within the asynchronous parallel gradient descent loops 154). Instead of transmitting large, dense weight matrices over network connections during collaborative learning operations, this layer uses a threshold-filtering mechanism to identify and transmit only the most impactful gradient updates.

By transmitting only, the gradients that exceed a calculated significance threshold, the system reduces cross-node network bandwidth requirements by up to ninety percent. This enables highly efficient decentralized learning setups over constrained cellular or satellite networks, allowing multiple edge nodes to collaboratively train a larger collective optimization model.

In multi-tenant environments, the system manages data flow isolation through an automated Cryptographic Multi-Tenant Context Matrix (implemented within the neural router 24 and memory mesh 40). This module ensures that when the adaptive neural router switches between context profiles belonging to different client tenants, the underlying data vectors, memory caches, and intermediate neural activations are isolated using hardware-level memory encryption keys.

The practical deployments of this framework span multiple industries. In smart grid management, the system streams high-frequency electrical telemetry from substations, using the router to activate localized power distribution experts that optimize energy balancing actions in real time while maintaining total resilience against sudden line surges or dropouts.

In automated supply chain logistics networks, the system processes real-time sensor streams tracking inventory, transport positions, and changing weather conditions. The optimization engine generates real-time routing adjustments for delivery fleets, avoiding unexpected disruptions and maximizing distribution throughput across global transport networks.

In high-frequency cloud infrastructure environments, the invention continuously reads server metrics including container CPU loads, I/O latency, and request rates. The engine uses this data to optimize resource allocation, dynamically spinning down underutilized nodes or migrating critical application workloads to alternative cloud zones before outages can manifest.

The physical execution of this software framework is typically deployed on a computing platform comprising a central processing unit (CPU), specialized hardware accelerators like graphical processing units (GPUs) or tensor processing units (TPUs), and a high-speed system memory architecture. The entire workflow operates deterministically to keep processing latency below the sub-millisecond thresholds required for industrial-scale deployment.

The claimed invention is:

1. An artificial intelligence system for real-time decision optimization in dynamic data environments, the system comprising: a streaming input pipeline executed by a processor configured to ingest a high-velocity multi-variant data stream from distributed source endpoints, said input pipeline transforming raw data payloads into high-dimensional input tensors; a context-aware adaptive neural router communicatively coupled to said streaming input pipeline, configured to extract a dense context signature from said high-dimensional input tensors and dynamically activate an optimized neural sub-network from an array of specialized experts while maintaining alternative sub-networks in an un-activated state; an evolving multi-tier memory allocation mesh structurally linked to said neural router, containing a transient short-term buffer, an episodic working memory cache, and a consolidated baseline core network configured to isolate and integrate continuous weight updates without structural performance degradation; and an inline optimization engine operating on an actor-critic paradigm coupled to said memory mesh, the optimization engine continuously processing the routed input tensors to output an optimized action vector to a target environment while synchronously updating internal gradient parameters via a parallelized gradient descent layer.

2. The system of claim 1, wherein said streaming input pipeline further comprises an inline anomaly-aware autoencoder configured to evaluate a reconstruction error score for each high-dimensional input tensor to detect data corruption.

3. The system of claim 2, wherein said anomaly-aware autoencoder isolates tensors exceeding a defined reconstruction error threshold and deploys an adversarial generative network component to synthesize alternative context-conditioned parameters within the input tensor stream.

4. The system of claim 1, wherein said context-aware adaptive neural router selects said optimized neural sub-network by performing a high-speed cosine similarity match between the extracted dense context signature and a historical directory of operational state definitions.

5. The system of claim 1, further comprising a multi-scale drift detection engine configured to monitor a statistical variance profile of the extracted dense context signatures and automatically instantiate a new specialized neural sub-network module upon detecting concept drift.

6. The system of claim 1, wherein said evolving multi-tier memory allocation mesh applies an elastic weight consolidation protocol utilizing a calculated Fisher information matrix to protect core parameter pathways within the consolidated baseline core network during integration cycles.

7. The system of claim 1, further comprising an automated resource-hardware adaptation matrix configured to interface with host operating system kernels to pull real-time computational metrics and dynamically execute structural parameter pruning and bit-width quantization on active neural pathways during resource constraints.

8. The system of claim 1, further comprising a deterministic safety guardrail controller positioned at the output of the inline optimization engine, the controller executing a validation check against an explicit lookup boundary matrix to intercept and scale down any anomalous action vectors.

9. The system of claim 1, further comprising a sparse gradient synchronization layer configured to evaluate computed gradient updates against a mathematical significance threshold and transmit only high-impact sparse updates across distributed network instances.

10. The system of claim 1, further comprising a cryptographic multi-tenant context matrix configured to enforce hardware-level isolated memory encryption keys across independent tenant data arrays during sub-network routing operations.

11. The system of claim 1, wherein said alternative sub-networks maintained in an un-activated state are selectively paged out of a primary graphical processing unit (GPU) virtual random-access memory (VRAM) cache to minimize static computational power overhead.

12. The system of claim 1, wherein said parallelized gradient descent layer of the inline optimization engine executes independent concurrent gradient updates across a plurality of asynchronous processing threads using lock-free atomic write paths directed to said memory mesh.

13. A method for real-time decision optimization in dynamic data environments via an artificial intelligence platform, the method comprising: ingesting, by a streaming input pipeline executed by a processor, a high-velocity multi-variant data stream from distributed source endpoints, and transforming raw data payloads into high-dimensional input tensors; extracting, by a context-aware adaptive neural router, a dense context signature from said high-dimensional input tensors to dynamically activate an optimized neural sub-network from an array of specialized experts while maintaining alternative sub-networks in an un-activated state; isolating and integrating continuous weight updates within an evolving multi-tier memory allocation mesh structurally linked to said neural router, the memory mesh segregating modifications across a transient short-term buffer, an episodic working memory cache, and a consolidated baseline core network without structural performance degradation; and processing continuously, by an inline optimization engine operating on an actor-critic paradigm, the routed input tensors to output an optimized action vector to a target environment while synchronously updating internal gradient parameters via a parallelized gradient descent layer.

14. The method of claim 13, further comprising: evaluating, via an inline anomaly-aware autoencoder within the streaming input pipeline, a reconstruction error score for each high-dimensional input tensor to flag data anomalies; and isolating tensors exceeding a defined reconstruction error threshold to inject alternative context-conditioned parameters synthesized by an adversarial generative network component.

15. The method of claim 13, wherein activating the optimized neural sub-network further comprises mapping the dense context signature against a historical directory using a rolling cosine similarity metric to establish a target data execution path.

16. The method of claim 13, further comprising tracking a statistical variance profile of the dense context signatures via a multi-scale drift detection engine, and automatically generating a new untrained expert node seeded with baseline weights from a closest-matching historical expert when concept drift is identified.

17. The method of claim 13, further comprising applying an elastic weight consolidation protocol within the memory mesh to preserve critical node pathways inside the consolidated baseline core network by executing a mathematical penalty based on a computed Fisher information matrix during synchronization intervals.

18. The method of claim 13, further comprising pulling real-time hardware performance metrics from a host operating system kernel and executing an automated model compression sequence comprising parameter pruning and runtime bit-width quantization down to integer representations upon detecting low memory or thermal restrictions.

19. The method of claim 13, further comprising intercepting the output optimized action vector at a deterministic safety guardrail controller, validating said vector against an explicit boundary matrix, and modifying the vector to stay within safe operational limits prior to deployment in the target environment.

20. A non-transitory computer-readable medium storing instructions that, when executed by a processing system, cause the processing system to perform a method for real-time decision optimization, the method comprising: transforming raw multi-variant data payloads from distributed source endpoints into standardized input tensor structures within an execution pipeline; generating a dense context signature vector from the input tensor structures to dynamically route the data stream through a prioritized expert sub-network while keeping alternative expert configurations dormant; apportioning localized learning optimization weights within a structural memory mesh across a transient buffer, an episodic cache, and a consolidated baseline core network to prevent catastrophic forgetting; and executing an actor-critic reinforcement learning loop on the routed input tensor stream to dispatch an optimized action vector to a target system environment while concurrently resolving internal gradient updates through a parallel threaded gradient descent architecture.
